(19) United States
(12) Patent Application Publication
(10) Pub. No.: US 2004/0075517 A1
(43) Pub. Date: Apr. 22, 2004

(54) Rod coil for ignition systems

(76) Inventors: Dieter Betz, Vaihingen (DE); Wolfram Schoellig, Stuttgart (DE); Klaus Lerchenmueller, Immenstadt (DE); Wolfgang Gaede, Marbach (DE); Christian Hauer, Remshalden (DE)

Correspondence Address: KENYON & KENYON, ONE BROADWAY, NEW YORK, NY, 10004, US

(21) Appl. No.: 10/433,522

(22) PCT Filed: Oct. 21, 2002
(86) PCT No.: PCT/DE02/03963

(30) Foreign Application Priority Data
Oct. 23, 2001 (DE) 10152177.4

(51) Int. Cl. H01F 27/02

(52) U.S. Cl. 336/90

(57) ABSTRACT

A rod coil (11) for ignition systems, in particular in the form of an ignition coil in internal combustion engines of motor vehicles, designed for long-term serviceability.

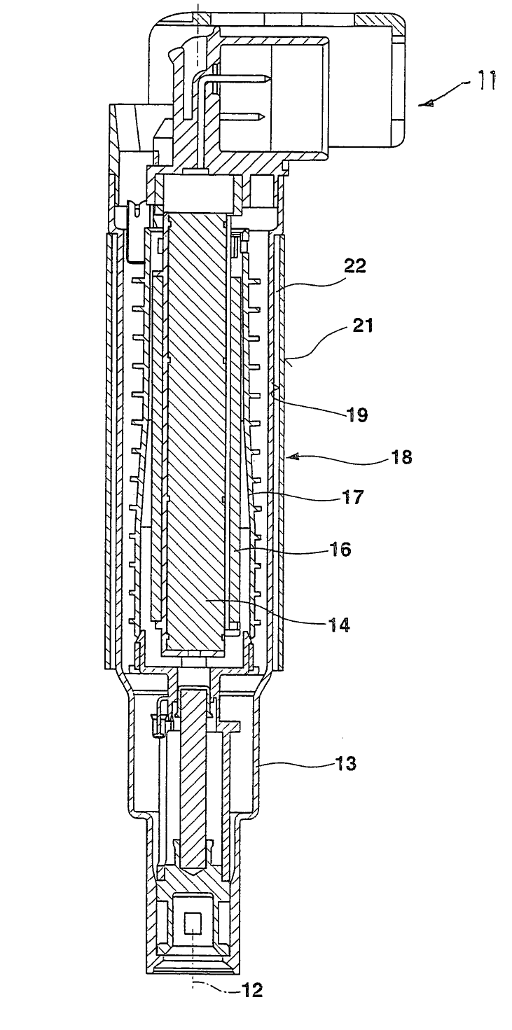

The rod coil (11) has a centrally located core (14) as the internal magnetic iron core and, on a housing (13), a yoke (18) made of plastic as the external magnetic iron core. To avoid partial electrical discharges on the rod coil (11), a fill body (22) is provided between the yoke (18) and housing (13) thereby forming an inner, gap-free bond between the yoke (18) and housing (13).

### BACKGROUND INFORMATION

The present invention is directed to a rod coil for ignition systems, in particular in the form of an ignition coil in internal combustion engines of motor vehicles according to the definition of the species in claim 1.

A rod coil having a cylindrical housing in the basic form is known from German Patent 196 23 399 C2. A rod-shaped core of an open magnetic circuit is centrally located in the housing and within a winding set. To control the magnetic field, the winding set is concentrically surrounded by a sleeve-shaped slotted yoke mounted on an inner wall or, alternatively, on an outer wall of the housing, an insulator being inserted in between. The purpose of this yoke is to close the magnetic field of the rod coil.

Due to unavoidable, production-related dimensional inaccuracies in the yoke and housing, air-filled cavities are produced between the two bodies when the yoke comes to rest against the housing. Partial electrical discharges that, over the long term, cause deterioration of the rod coil insulation through material wear, possibly resulting in coil failure, occur at these voids during rod coil operation.

### ADVANTAGES OF THE INVENTION

The rod coil for ignition systems according to the present invention, having the characterizing features of claim 1, has the advantage that it avoids the inadequacy mentioned above. For this purpose, the rod coil is designed so that a fill body is positioned between the yoke and housing. This fill body causes the housing to rest snugly without gaps against the yoke so that no partial electrical discharges occur during rod coil operation, and the rod coil is protected against failure due to deterioration of its insulation.

Advantageous refinements for implementing the present invention are specified in the subordinate claims.

### DRAWING

One exemplary embodiment of the present invention is illustrated in the drawing and explained in greater detail in the description of the FIGURE. The sole FIGURE shows a longitudinal section of the rod coil in which the dimensions of a fill body between a yoke and housing of the rod coil are enlarged to improve visual clarity.

### DESCRIPTION OF THE EXEMPLARY EMBODIMENT

A rod coil 11 for ignition systems according to the FIGURE, in particular in the form of an ignition coil in internal combustion engines of motor vehicles, is provided for direct contacting with a spark plug, which is inserted in the usual manner into a shaft in the cylinder head of an internal combustion engine and is not illustrated in further detail here.

Rod coil 11 includes a longitudinal cylindrical core 14 made of plastic that is positioned coaxially to a longitudinal axis 12 in a housing 13 and is also known as the I core. Core 14 is made of a coated magnetizable material and is part of an open magnetic circuit. Located concentrically around core 14 is an internally mounted, low-voltage-conducting primary winding 16 and an externally mounted high-voltage-conducting secondary winding 17.

To control the magnetic field of rod coil 11, windings 16, 17 are surrounded by a yoke 18 that is made of a magnetizable material and is mounted on an inner wall 19 of housing 13. Alternatively, yoke 18 is also mountable on an outer wall 21 of housing 13. Yoke 18 is slotted parallel to longitudinal axis 12 to prevent a short circuit of the magnetic field.

A fill body 22 is provided between yoke 18 and housing 13—between yoke 18 and inner wall 19 of housing 13 in the exemplary embodiment illustrated here. This fill body 22 may be designed as a hot-melt adhesive and be made, for example, of polyolefin, polyamide or a silicone-based material.

Fill body 22 may also be in the form of an epoxy resin coating that may be both electrically conductive and electrically insulating and is attached to housing 13 or yoke 18.

In the case of a yoke 18 surrounding housing 13, fill body 22 is alternatively mountable on outer wall 21 of housing 13, in particular if fill body 22 is in the form of a heat-shrinkable sleeve.

In any case, fill body 22 makes it possible to establish an inner, gap-free bond between yoke 18 and housing 13. The avoidance of cavities between yoke 18 and housing 13 prevents partial electrical discharges from occurring on rod coil 11 during the operation thereof. This prevents rod coil 11 from failing due to deterioration of its insulation.

What is claimed is:

1. A rod coil for ignition systems, in particular in the form of an ignition coil in internal combustion engines of motor vehicles, having, in the basic form, a hollow cylindrical housing (13) in which a core (14) is centrally located as an internal magnetic iron core and on which a yoke (18) is mounted as an external magnetic iron core, wherein a fill body (22) is positioned between the housing (13) and the yoke (18).

2. The rod coil as recited in claim 1,
wherein the fill body (22) is mounted on an outer wall (21) of the housing (13).

3. The rod coil as recited in claim 1,
wherein the fill body (22) is mounted on an inner wall (19) of the housing (13).

4. The rod coil as recited in one of the preceding claims,
wherein the fill body (22) is a hot-melt adhesive.

5. The rod coil as recited in claim 4,
wherein the fill body (22) is a hot-melt adhesive made of polyolefin.

6. The rod coil as recited in claim 4,
wherein the fill body (22) is a hot-melt adhesive made of polyamide.

7. The rod coil as recited in claim 4,
wherein the fill body (22) is a silicone-based hot-melt adhesive.

8. The rod coil as recited in one of claims 1 through 3,
wherein the fill body (22) is an epoxy resin coating.

9. The rod coil as recited in claim 8,
wherein, as the fill body (22), the epoxy resin coating is electrically conductive.

10. The rod coil as recited in claim 8,
wherein, as the fill body (22), the epoxy resin coating is electrically insulating.

11. The rod coil as recited in claim 2,
wherein the fill body (22) is a heat-shrinkable sleeve that is mounted on the outer wall (21) of the housing (13).
